(19) United States
(12) Patent Application Publication
(10) Pub. No.: US 2011/0064980 A1
(43) Pub. Date: Mar. 17, 2011

(54) CATHODIC ACTIVE MATERIAL , CATHODE, AND NONAQUEOUS SECONDARY BATTERY

(75) Inventors: Koji Ohira, Osaka-shi (JP); Motoaki Nishijima, Osaka-shi (JP); Toshitsugu Sueki, Osaka-shi (JP); Shougo Esaki, Osaka-shi (JP); Isao Tanaka, Kyoto-shi (JP); Yukinori Koyama, Kyoto-shi (JP); Katsuhisa Tanaka, Kyoto-shi (JP); Koji Fujita, Kyoto-shi (JP); Shunsuke Murai, Kyoto-shi (JP)

(73) Assignee: SHARP KABUSHIKI KAISHA, Osaka (JP)

(21) Appl. No.: 12/873,539

(22) Filed: Sep. 1, 2010

(30) Foreign Application Priority Data
Sep. 2, 2009 (JP) 2009-202980
Aug. 25, 2010 (JP) 2010-188167

(51) Int. Cl. H01M 4/131; H01M 10/02; H01M 4/88; H01M 4/505; H01M 10/0587

(52) U.S. Cl. 429/94; 429/221; 429/156; 252/182.1

(57) ABSTRACT

A cathodic active material according to the present invention has a composition represented by general formula (1):

Li₍₁₋ₐ₎AₐFe_{(1-x-b)}M_{(x-c)}P_{(1-y)}Si_{y}O₄ (1),

where A is at least one type of element selected from the group consisting of Na, K, Fe, and M; Fe has an average valence of +2 or more; M is an element having a valence of +2 or more and at least one type of element selected from the group consisting of Zr, Sn, Y, and Al, the average valence of M being different from the average valence of Fe; 0<a≦0.125; a=b+c+d, where b is the number of moles of Fe in A, c is the number of moles of M in A, and d is the total number of moles of Na and K in A; 0<x≦0.5; and 0<y≦0.5. This makes it possible to realize a cathodic active material that not only excels in terms of safety and cost but also can provide a long-life battery.

This Nonprovisional application claims priority under 35 U.S.C. §119(a) on Patent Application No. 2009-202980 filed in Japan on Sep. 2, 2009 and Patent Application No. 2010-188167 filed in Japan on Aug. 25, 2010, the entire contents of which are hereby incorporated by reference.

### TECHNICAL FIELD

The present invention relates to a cathodic active material, a cathode in which such a cathodic active material is used, a nonaqueous secondary battery (lithium secondary battery) in which such a cathode is used. More specifically, the present invention relates to a nonaqueous secondary battery excellent in cycling characteristics.

### BACKGROUND ART

Lithium secondary batteries have been in practical and widespread use as secondary batteries for portable electronic devices. Furthermore, in recent years, lithium secondary batteries have drawn attention not only as small-sized secondary batteries for portable electronic devices but also as high-capacity devices for use in vehicles, power storage, etc. Therefore, there has been a growing demand for higher safety standards, lower costs, longer lives, etc.

A lithium secondary battery is composed mainly of a cathode, an anode, an electrolyte, a separator, and an armoring material. Further, the cathode is constituted by a cathodic active material, a conductive body, a power collector, and a binder (binding agent).

In general, the cathodic active material is realized by a layered transition metal oxide such as LiCoO₂. However, in a state of full charge, such layered transition metal oxides are prone to cause oxygen desorption at a comparatively low temperature of approximately 150° C., and such oxygen desorption may cause a thermal runaway reaction in the battery. Therefore, when a battery having such a cathodic active material is used for a portable electronic device, there is a risk of an accident such as heating, firing, etc. of the battery.

For this reason, in terms of safety, expectations have been placed on lithium manganate (LiMn₂O₄) having a spinel-type structure, lithium iron phosphate (LiFePO₄) having an olivine-type structure, etc. that are stable in structure and do not emit oxygen in abnormal times.

Further, in terms of cost, cobalt (Co) is low in degree of existence in the earth's crust and high in price. For this reason, expectations have been placed on lithium nickel oxide (LiNiO₂) or a solid solution thereof (Li(CO₁₋ₓNiₓ)O₂), lithium manganate (LiMn₂O₄), lithium iron phosphate (LiFePO₄), etc.

Further, in terms of longevity, the insertion and desorption of Li into and from a cathodic active material along with charging and discharging cause structural destruction in the cathodic active material. For this reason, more expectations have been placed on lithium manganate (LiMn₂O₄) having a spinel-type structure, lithium iron phosphate (LiFePO₄) having an olivine-type structure, etc. than on layered transition metal oxides because of their structural stability.

Therefore, for example, such lithium iron phosphate having an olivine-type structure has drawn attention as a cathodic active material for a battery in consideration of safety, cost, and longevity. However, when lithium iron phosphate having an olivine-type structure is used as a cathodic active material for a battery, there are such declines in charge-discharge behavior as insufficient electron conductivity and low average potential.

In order to improve charge-discharge behavior, there has been proposed an active material represented by general formula AₐM_{b}(XY₄)_{c}Z_{d} (where A is an alkali metal, M is a transition metal, XY₄ is PO₄ or the like, and Z is OH or the like) (e.g., see Patent Literature 1).

Further, there have been also proposed an active material, represented by general formula LiMP₁₋ₓAₓO₄ (where M is a transition metal, A is an element having an oxidation number of +4 or less, and 0<X<1), whose P site has been replaced by the element A (e.g., see Patent Literature 2).

Further proposed as a cathodic active material for a nonaqueous electrolyte secondary battery excellent in large-current charge-discharge behavior is a material represented by general formula Li₁₋ₓAₓFe_{1-Y-Z}M_{y}Me_{z}P₁₋ₘXₘO₄₋ₙZₙ (where A is Na or K; M is a metal element other than Fe, Li, and Al; X is Si, N, or As; Z is F, Cl, Br, I, S, or N) (e.g., see Patent Literature 3). Further proposed as an electrode active material that can be economically produced, is satisfactory in charging capacity, and is satisfactory in rechargeability over many cycles is a material represented by general formula Aₐ₊ₓM_{b}P₁₋ₓSiₓO₄ (where A is Ki or Na, or K; and M is a metal) (e.g., see Patent Literature 4).

### CITATION LIST

### Patent Literature 1

Japanese Translation of PCT International Publication, Tokuhyo, No. 2005-522099 A (Publication Date: Jul. 21, 2005)

### Patent Literature 2

Japanese Translation of PCT International Publication, Tokuhyo, No. 2008-506243 A (Publication Date: Feb. 28, 2008)

### Patent Literature 3

Japanese Patent Application Publication, Tokukai, No. 2002-198050 (Publication Date: Jul. 12, 2002)

### Patent Literature 4

Japanese Translation of PCT International Publication, Tokuhyo, No. 2005-519451 A (Publication Date: Jun. 30, 2005)

### SUMMARY OF INVENTION

### Technical Problem

Unfortunately, however, the active materials structured as described in Patent Literatures 1 to 4 above result in short-life batteries.

Specifically, according to the structures of the active materials as described in Patent Literatures 1 to 4, the insertion and desorption of Li into and from a cathodic active material along with charging and discharging cause great expansion or contraction in the cathodic active material; therefore, an increase in the number of cycles may cause the cathodic active material to gradually detach from the power collector and the conductive body physically and therefore cause structural destruction in the cathodic active material. This is because a material that greatly expands or contracts due to charging and discharging causes destruction of secondary particles and destruction of the conductive path between the cathodic active material and the conductive body and therefore causes an increase in internal resistance of the battery. This results in an increase in active materials that do not contribute to charging or discharging, causes a decrease in capacity, and therefore makes the battery short lived.

As mentioned above, there has been a demand for cathodic active materials excellent in terms of safety, cost, and longevity. However, the active materials structured as described in Patent Literatures 1 and 2 above are high in rate of expansion and contraction in volume (rate of change in volume) during charging and discharging and therefore result in short lives.

The present invention has been made in view of the foregoing problems, and it is an object of the present invention to realize a cathodic active material that not only excels in terms of safety and cost but also can provide a long-life battery, a cathode in which such a cathodic active material is used, a nonaqueous secondary battery in which such a cathode is used.

### Solution to Problem

The present invention extends the life of a battery through suppression of expansion and contraction by carrying out element substitution with use of lithium iron phosphate as a basic structure.

Specifically, in order to solve the foregoing problems, a cathodic active material according to the present invention has a composition represented by general formula (1):

Li₍₁₋ₐ₎AₐFe_{(1-x-b)}M_{(x-c)}P_{(1-y)}Si_{y}O₄ (1),

where A is at least one type of element selected from the group consisting of Na, K, Fe, and M; Fe has an average valence of +2 or more; M is an element having a valence of +2 or more and at least one type of element selected from the group consisting of Zr, Sn, Y, and Al, the average valence of M being different from the average valence of Fe; 0<a≦0.125; a=b+c+d, where b is the number of moles of Fe in A, c is the number of moles of M in A, and d is the total number of moles of Na and K in A; 0<x≦0.5; and 0<y≦0.5.

According to the foregoing structure, a change in volume during Li insertion and desorption can be suppressed by replacing at least part of P site with Si, replacing part of Fe site with an element capable of compensation for charges in the crystal structure, and replacing at least part of Li site with Na, K, Fe, Zr, Sn, Y, or Al. As a result, in the case of a battery made with use of such a cathodic active material, the cathode can be prevented from expanding or contracting due to charging and discharging. This brings about an effect of providing a cathodic active material that not only excels in terms of safety and cost but also can provide a long-life battery.

Furthermore, Zr, Sn, Y, and Al are easily combined because they do not change in valence, can be combined in a reducing atmosphere, and do not require control of the partial pressure of oxygen for controlling the valence of a substituting element.

In order to solve the foregoing problems, a cathode according to the present invention includes: such a cathodic active material according to the present invention; a conductive body; and a binding agent.

According to the foregoing structure, the inclusion of such a cathodic active material according to the present invention brings about an effect of providing a cathode that not only excels in terms of safety and cost but also can provide a long-life battery.

In order to solve the foregoing problems, a nonaqueous secondary battery according to the present invention includes: such a cathode according to the present invention; an anode; an electrolyte; and a separator.

According to the foregoing structure, the inclusion of such a cathode according to the present invention brings about an effect of providing a long-life battery excellent in terms of safety and cost.

A module according to the present invention includes a combination of such nonaqueous secondary batteries according to the present invention.

A power storage system according to the present invention includes such a nonaqueous secondary battery according to the present invention.

### ADVANTAGEOUS EFFECTS OF INVENTION

As described above, a cathodic active material according to the present invention has a composition represented by general formula (1).

This brings about an effect of providing a cathodic active material that not only excels in terms of safety and cost but also can provide a long-life battery.

Further, as described above, a cathode according to the present invention includes: such a cathodic active material according to the present invention; a conductive body; and a binding agent.

This brings about an effect of providing a cathode that not only excels in terms of safety and cost but also can provide a long-life battery.

Furthermore, as described above, a nonaqueous secondary battery according to the present invention includes: such a cathode according to the present invention; an anode; an electrolyte; and a separator.

This brings about an effect of not only excelling in terms of safety and cost but also being able to provide a long-life battery.

### BRIEF DESCRIPTION OF DRAWINGS

FIG. 1 is a graph showing relationships between the amount of substitution a of Li site for Na of K in general formula (1) and the discharging capacity ratio for a cathodic active material at different particles diameters of 10 nm, 50 nm, 100 nm, and 200 nm.

FIG. 2 is a perspective view schematically showing the structure of a flat-plate laminate battery prepared in Example 10.

FIG. 3 is a perspective view schematically showing the structure of a layered cuboidal battery prepared in Example 11.

FIG. 4 is a perspective view schematically showing the structure of a wound cylindrical battery prepared in Example

### DESCRIPTION OF EMBODIMENTS

The present invention is described below in detail. It should be noted, in this specification, that the range “A to B” means “A or more to B or less”. Further, the various properties enumerated in this specification mean values measured by methods described later in Examples, unless otherwise noted.

(1) Cathodic Active Material

A cathodic active material according to the present embodiment has a composition represented by general formula (1):

Li₍₁₋ₐ₎AₐFe_{(1-x-b)}M_{(x-c})P_{(1-y)}Si_{y}O₄ (1),

where A is at least one type of element selected from the group consisting of Na, K, Fe, and M; Fe has an average valence of +2 or more; M is an element having a valence of +2 or more and at least one type of element selected from the group consisting of Zr, Sn, Y, and Al, the average valence of M being different from the average valence of Fe; 0<a≦0.125; a=b+c d, where b is the number of moles of Fe in A, c is the number of moles of M in A, and d is the total number of moles of Na and K in A; 0<x≦0.5; and 0<y≦0.5.

When A in general formula (1) is Na or K, the cathodic active material according to the present embodiment has a composition represented by general formula:

Li₍₁₋ₐ₎AₐFe₍₁₋ₓ₎MₓP_{(1-y)}Si_{y}O₄,

where A is Na or K; Fe has an average valence of +2 or more; M is an element having a valence of +2 or more and at least one type of element selected from the group consisting of Zr, Sn, Y, and Al, the valence of M being different from the average valence of Fe; 0<a≦0.125; 0<x≦0.5; and y=x×(average valence of M−2)+(1−x)×(average valence of Fe−2).

The term “average valence of Fe” here means the average of the valences of all the Fe atoms constituting the cathodic active material.

In general, in the case of olivine-type lithium iron phosphate, there is a contraction in volume during desorption of Li from the initial structure due to charging. During this structural change, there are contractions along the a axis and the b axis, and there is an expansion along the c axis. For this reason, the inventors found it possible to suppress a change in volume by reducing the rates of contraction along the a axis and the b axis and increasing the rate of expansion along the c axis through any sort of substitution.

Then, the inventors found that by replacing part of P site with Si, replacing part of Fe site with another atom, and replacing at least part of Li site with any one of Na, K, Fe, Zr, Sn, Y, and Al, compensation for charges in the crystal structure is made and a change in volume during Li desorption is suppressed, whereby expansion and contraction due to charging and discharging are also suppressed.

Furthermore, the inventors found that the substitution of an atom of Fe site in Li site causes a loss in Fe site to enable diffusion along the a axis, whereby a capacity can be obtained even when the primary particles have a particle diameter of 100 nm or larger.

It should be noted that although most of the materials that have compositions represented by general formula (1) have olivine-type structures, the scope of the present invention is not limited to those materials which have olivine-type structures. Those materials which do not have olivine-type structures are also encompassed in the scope of the present invention.

In the cathodic active material according to the present embodiment, P site has been replaced by Si, and P and Si are different in valence from each other. Therefore, it is necessary to make compensation for charges in the crystal structure. For this reason, Fe site has been replaced by M.

That is, because the valences of P and Si in general formula (1) are +5 and +4, respectively, the amount of substitution y of Si comes to satisfy y=(x−c)×(average valence of M)+(1−x−b)×(average valence of Fe)−2+b+c according to the principle that the total of charges in the structure is 0.

When the average valence of M in general formula (1) is 2 or more and less than 3, it is preferable that y fall within the range x≦y<(x+0.05). When the average valence of M in general formula (1) is 3 or more, it is preferable that y fall within the range (x×(average valence of M−2))≦y<(x×(average valence of M−2)+0.05).

Further, it is preferable that a≦x in general formula (1). During charging and discharging, the same amount of Li as x cannot contribute to charging or discharging regardless of the value of a. For this reason, if a≦x in general formula (1), a change in valence of Fe can be fully used.

Furthermore, it is preference that a in general formula (1) be 0<a≦0.125, or more preferably 0<a≦0.05.

Although Fe in general formula (1) can generally take on a valence of +2 or +3, it is preferable that its average valence be +2, and it is more preferable that every Fe have a valence of +2.

Further, in the present embodiment, it is preferable that assuming that k is the content of Li in general formula (1), the rate of change in volume of the volume of a unit lattice in a case where k is (x+b−a) (where k is 0 when x+b−a<0) relative to the volume of a unit lattice in a case where k is (1−a) is 5% or less, more preferably 4% or less, or still more preferably 3% or less.

The reason for this is that the cathodic active material according to the present embodiment has a change in slope of the capacity maintenance ratio relative to the rate of change in volume at a point where the rate of change in volume (rate of expansion and contraction due to charging and discharging) of the volume of a unit lattice reaches approximately 5%. That is, when the rate of change in volume becomes higher than approximately 5%, the capacity maintenance ratio comes to decrease to a greater extent than the rate of change in volume increases. Therefore, if the rate of change in volume is approximately 5% or less, it is possible to better suppress a decrease in capacity maintenance ratio.

Further, in the present embodiment, it is preferable that the ratio of the initial discharging capacity of a unit lattice in general formula (1) to the initial discharging capacity of a unit lattice in LiFe₍₁₋ₓ₎MₓP_{(1-y)}Si_{y}O₄ is 30% or more. If the amount of substitution a of Li site in general formula (1) is large, the rate of change in volume of the cathodic active material can be made lower. Meanwhile, an increase in active materials that do not contribute to insertion or desorption causes a decrease in initial discharging capacity of the battery. If the discharging capacity ratio in a cathodic active material according to the present invention is 30% or more, it is possible to provide a cathodic active material that can provide a long-life battery while securing a certain level of initial discharging capacity.

The term “initial discharging capacity” here means the discharging capacity (mAh/g) of a cathodic active material in the immediate post-synthetic period where it has not gone through any charge-discharge cycle.

Further, the ratio of initial discharging capacity (hereinafter referred to also as “discharging capacity ratio”) can be presented by formula (2):

Discharging capacity ratio (%)=Initial discharging capacity of unit lattice in general formula (1)/Initial discharging capacity of unit lattice in LiFe₁₋ₓMₓP_{1-y}Si_{y}O₄×100 (2).

Further, the cathodic active material according to the present invention is preferably structured such that the particle diameter of primary particles is 5 nm to 100 nm, more preferably 10 nm to 100 nm, or still more preferably 10 nm to 50 nm. However, it is considered that in the case of substitution of Fe in Li site, there occurs a defect in Fe site, whereby a diffusion path along the a axis is formed. Therefore, the particle diameter of the primary particles may be 100 nm or larger or, specifically, preferably 5 nm to 500 nm or more preferably 10 nm to 300 nm.

The particle diameter of the primary particles can be measured, for example, by measuring a particle size distribution or making an observation with use of a transmission electron microscope (TEM) or a scanning electron microscope (SEM).

As will be described in Examples below, an increase in particle diameter of the primary particles entails the need to make the amount of substitution a of Li site smaller so as to suppress a decrease in discharging capacity ratio. However, if the particle diameter of the primary particles of the cathodic active material falls within the above range, it is possible to make the amount of substitution a of Li site in general formula (1) larger while suppressing a decrease in discharging capacity ratio. As mentioned above, if the amount of substitution a of Li site in general formula (1) is large, the rate of change in volume of the cathodic active material can be made lower. This makes it possible to provide a cathodic active material capable of providing a longer-life battery.

The amount of substitution x on Fe site falls within a range of larger than 0 to 0.5 or smaller, and the amount of substitution a on Li site falls within a range of larger than 0 to 0.125 or smaller. If the amount of substitution x on Fe site and the amount of substitution a on Li site fall within the above ranges, respectively, it is possible to prevent a change in volume from occurring during Li insertion and desorption.

When the element A, which replaces Li site, is Na or K, K makes it possible to maintain structural stability for a longer time, because K is larger in atomic radius and more highly effective in maintaining the structure. Therefore, it is more preferable that Li site be replaced by K. Furthermore, when the element that replaces Li site is an element of Fe site, there occurs a loss in Fe site, which enables diffusion along the a axis and therefore favorably enables two-dimensional diffusion.

The larger the amount of substitution x on Fe site and the amount of substitution a on Li site are, the better the rate of change in volume can be suppressed. In other words, the larger the amount of substitution x on Fe site and the amount of substitution a on Li site are, the better the capacity maintenance ratio is at 500 cycles. If the rate of change in volume is 4% or less, the capacity maintenance ratio can be 90% or more.

The element M, which replaces Fe site, is an element capable of taking on a valence of +2 or more and at least one type of element selected from the group consisting of Zr, Sn, Y, and Al. Further, it is preferable that the element M, which replaces Fe site, by an element having a valence of +3 or +4. For a greater effect of suppressing the rate of change in volume, it is more preferable that Fe site be replaced by an element having a valence of +4.

It is preferable that the trivalent element M, which replaces Fe site, be Y, because Y does not change in valence during synthesis. Since there occurs no change in valence during synthesis, the cathodic active material can be synthesized stably.

It is preferable that the tetravalent element M, which replaces Fe site, be Zr or Sn, because Zr and Sn do not change in valence during synthesis. Since there occurs no change in valence during synthesis, the cathodic active material can be synthesized stably. In order to make the rate of change in volume of a unit lattice 3% or less, it is preferable that the tetravalent element M, which replaces Fe site, be Zr.

It is preferable that M in general formula (1) have a valence of +3 or +4, and it is more preferable that every M have a valence of +3 or that every M have a valence of +4.

Further, when Fe site is replaced by metal atoms having a valence of +3 and every Fe has a valence of +2, the same amount of Si as the amount of substitution of Fe site is required for the maintenance of electroneutrality.

Alternatively, when Fe site is replaced by metal atoms having a valence of +4 and every Fe has a valence of +2, the amount of Si twice as large as the amount of substitution of Fe site is required for the maintenance of electroneutrality.

Furthermore, it is preferable that M in general formula (1) be a mixture of a valence of +4 and a valence of +3, and it is more preferable that M be replaced by Zr and Al. For example, simultaneous substitution of Zr, which is highly effective in suppressing expansion and contraction, and Al, which small in atomic radius, makes it possible to obtain a cathodic active material excellent in battery life and discharging characteristic.

The aforementioned cathodic active material according to the present embodiment can be produced by using any combination of a carbonate of each element, a hydroxide of each element, a chloride salt of each element, a sulfate salt of each element, an acetate salt of each element, an oxide of each element, an oxalate of each element, a nitrate salt of each element, etc. as raw materials. Examples of production methods include methods such as a solid-phase method, a sol-gel process, melt extraction, a mechanochemical method, a coprecipitation method, a hydrothermal method, evaporative decomposition, etc. Further, as has been commonly done in olivine-type lithium iron phosphate, electrical conductivity may be improved by covering the cathodic active material with a carbon film.

As described above, the cathodic active material according to the present invention is preferably structured such that assuming that k is the content of Li in general formula (1), the rate of change in volume of the volume of a unit lattice in a case where k is (x+b−a) (where k is 0 when x+b−a<0) relative to the volume of a unit lattice in a case where k is (1−a) is 5% or less.

According to the foregoing structure, the rate of change in volume is 5% or less. This makes it possible to better prevent a cathode from expanding or contracting due to charging and discharging, thus making it possible to provide a cathodic active material capable of providing a longer-life battery.

The cathodic active material according to the present invention is preferably structured such that A in general formula (1) is Fe or M.

The cathodic active material according to the present invention is preferably structured such that M in general formula (1) has a valence of +4.

The cathodic active material according to the present invention is preferably structured such that M in general formula (1) is Zr.

The cathodic active material according to the present invention is preferably structured such that M in general formula (1) includes at least Zr and Al.

According to the foregoing structure, a cathodic active material excellent in battery life and discharging characteristic can be obtained by simultaneous substitution of Zr, which is highly effective in suppressing expansion and contraction, and Al, which small in atomic radius.

(II) Nonaqueous Secondary Battery

A nonaqueous secondary battery according to the present embodiment has a cathode, an anode, an electrolyte, and a separator. Each of the components is described below.

(a) Cathode

The cathode, composed of such a cathodic active material according to the present embodiment, a conductive body, and a binder, can be made, for example, by a publicly-known method such as application to a power collector of a slurry obtained by mixing the active material, the conductive body, and the binder with an organic solvent.

Usable examples of the binder (binding agent) include polytetrafluoroethylene, polyvinylidene fluoride, polyvinylchloride, ethylene-propylene diene polymer, styrene-butadiene rubber, acrylonitrile-butadiene rubber, fluorocarbon rubber, polyvinyl acetate, polymethyl methacrylate, polyethylene, nitrocellulose, etc.

Usable examples of the conductive body include acetylene black, carbon, graphite, natural graphite, artificial graphite, needle coke, etc.

Usable examples of the power collector include a foam (porous) metal having continuous holes, a metal shaped in a honeycomb pattern, a sintered metal, an expanded metal, nonwoven cloth, a plate, foil, a perforated plate, perforated foil, etc.

Usable examples of the organic solvent include N-methylpyrrolidone, toluene, cyclohexane, dimethylformamide, dimethylacetoamide, methyl ethyl ketone, methyl acetate, methyl acrylate, diethyltriamine, N—N-dimethylaminopropylamine, ethylene oxide, tetrahydrofuran, etc.

It is preferable that the cathode have a thickness of approximately 0.01 to 20 mm. Too great a thickness undesirably causes a decrease in electrical conductivity, and too small a thickness undesirably causes a decrease in capacity par unit area. It should be noted that the cathode, obtained by application and drying, may be consolidated by a roller press, etc. so that the active material has a higher filling density.

(b) Anode

The anode can be made by a publicly-known method. Specifically, the anode can be made by the same method as described in the method for making the cathode, i.e., by mixing such a publicly-known binding agent and such a publicly-known conductive body as named in the method for making the cathode with an anodic active material, molding the mixed powder into a sheet, and then pressure-bonding the molded product to a net (power collector) made of a conducting material such as stainless steel or copper. Alternatively, the anodic can also be made by applying, onto a substrate made of metal such as copper, a slurry obtained by mixing the mixed powder with such a publicly-known organic solvent as named in the method for making the cathode.

The anodic active material may be a publicly-known material. In order to constitute a high-energy density battery, it is preferable that the potential of insertion/desorption of lithium be close to the deposition/dissolution potential of metal lithium. Typical examples of such an anodic active material include carbon materials such as natural or artificial graphite in the form of particles (scales, clumps, fibers, whisker, spheres, crushed particles, etc.).

Examples of the artificial graphite include graphite obtainable by graphitizing mesocarbon microbeads, mesophase pitch powder, isotropic pitch powder, etc. Alternatively, it is possible to use graphite particles having amorphous carbon adhering to their surfaces. Among these, natural graphite is more preferable because it is inexpensive, close in oxidation-reduction potential to lithium, and can constitute a high-energy density battery.

Alternatively, it is possible to use a lithium transition metal oxide, a transition metal oxide, oxide silicon, etc. as the anodic active material. Among these, Li₄Ti₅O₁₂ is more preferable because it is high in potential flatness and small in volume change due to charging and discharging.

(c) Electrolyte

Usable examples of the electrolyte include an organic electrolyte, a gel electrolyte, a polymer solid electrolyte, an inorganic solid electrolyte, a molten salt, etc. After injection of the electrolyte, an opening in the battery is sealed. It is possible to turn on electricity before the sealing and remove gas generated.

Examples of an organic solvent that constitutes the organic electrolyte include: cyclic carbonates such as propylene carbonate (PC), ethylene carbonate (EC), and butylene carbonate; chain carbonates such as dimethyl carbonate (DMC), diethyl carbonate (DEC), ethyl methyl carbonate, and dipropyl carbonate; lactones such as γ-butyrolactone (GBL), γ-Valerolactone; furans such as tetrahydrofuran and 2-methyl tetrahydrofuran; ethers such as diethyl ether, 1,2-dimethoxy ethane, 1,2-diethoxy ethane, ethoxy methoxy ethane, dioxane; dimethyl sulfoxide; sulforan; methyl sulforan; acetonitrile; methyl formate; methyl acetate; etc. These organic solvents can be used alone or in combination of two or more of them.

Further, the cyclic carbonates such as PC, EC, and butylene carbonate are high boiling point solvents and, as such, are suitable as a solvent to be mixed with GBL.

Examples of an electrolyte salt that constitutes the organic electrolyte include lithium salts such as fluoroboric lithium (LiBF₄), lithium hexafluorophosphate (LiPF₆), trifluoromethanesulfonic lithium (LiCF₃SO₃), trifluoroacetic lithium (LiCF₃COO), lithium-bis(trifluoromethanesulfone)imide (LiN(CF₃SO₂)₂), etc. These electrolyte salts can be used alone or in combination of two or more of them. A suitable salt concentration of the electrolyte is 0.5 to 3 mol/l.

(d) Separator

Examples of the separator include a porous material, nonwoven cloth, etc. It is preferable that the separator be made of such a material as mentioned above that neither dissolves not swells in response to the organic solvent contained in the electrolyte. Specific examples are polyester polymers, polyolefin polymers (e.g., polyethylene, polypropylene), ether polymers, and inorganic materials such glass, etc.

The components, such as the separator, a battery case, and other structural materials, of the battery according to the present embodiment may be, but are not particularly limited to, various materials that are used in a conventional publicly-known nonaqueous secondary battery.

It should be noted that it is preferable that the nonaqueous secondary battery according to the present invention be a laminate battery, a layered cuboidal battery, a wound cuboidal battery, or a wound cylindrical battery.

Further, the nonaqueous secondary battery according to the present invention can be used in a power storage system. It is preferable that the power storage system according to the present invention be a solar power storage system, a midnight power storage system, a wind power storage system, a geothermal power storage system, or a wave power storage system.

(e) Method for Producing a Nonaqueous Secondary Battery

The nonaqueous secondary battery according to the present embodiment can be made, for example, by layering the cathode and the anodic in such a way that the separator is sandwiched between them. The layered electrode may have a rectangular planar shape. Further, when a cylindrical or flat battery is made, the layered electrode may be wound.

Such a single layered electrode or a plurality of such layered electrodes is/are inserted into a battery container. Usually, the cathode(s) and the anodic(s) are each connected to an external conductive terminal of the battery. After that, the battery container is sealed so that the electrode(s) and the separator(s) are shielded from outside air.

In the case of a cylindrical battery, the battery container is usually sealed by fitting a resin gasket in the opening of the battery container and then caulking the battery container. In the case of a cuboidal battery, the battery container can be sealed by mounting a metal lid (called a sealing plate) on the opening and then joining them by welding. Other than these methods, the battery container can be sealed by a binding agent or by fastening it with a bolt through a gasket. Furthermore, the battery container can be sealed by a laminate film obtained by joining a thermoplastic resin on top of metal foil. When sealed, the battery container may be provided with an opening through which the electrolyte is injected.

It should be noted the present invention, described above, can be rephrased as follows:

(1) A cathodic active material having a composition represented by general formula (1′):

Li₍₁₋ₐ₎AₐFe₍₁₋ₓ₎MₓP_{(1-y)}Si_{y}O₄ (1′),

where A is Na or K; Fe has an average valence of +2 or more; M is an element having a valence of +2 or more and at least one type of element selected from the group consisting of Zr, Sn, Y, and Al, the valence of M being different from the average valence of Fe; 0<a≦0.125; 0<x≦0.5; and y=x×(valence of M−2)+(1−x)×(average valence of Fe−2).

(2) The cathodic active material as set forth in (1), wherein a≦x in general formula (1′).

During charging and discharging, the same amount of Li as x cannot contribute to charging or discharging regardless of the value of a. For this reason, if a≦x in general formula (1′), a change in valence of Fe can be fully used.

(3) The cathodic active material as set forth in (1) or (2), wherein assuming that k is the content of Li in general formula (1′), the rate of change in volume of the volume of a unit lattice in a case where k is (x−a) (where k is 0 when x−a<0) relative to the volume of a unit lattice in a case where k is (1−a) is 4% or less.

(4) The cathodic active material as set forth in any one of (1) to (3), wherein the ratio of the initial discharging capacity of a unit lattice in general formula (1′) to the initial discharging capacity of a unit lattice in LiFe₍₁₋ₓ₎MₓP_{(1-y)}Si_{y}O₄ is 30% or more.

According to the foregoing structure, the ratio of initial discharging capacity (hereinafter referred to as “discharging capacity ratio”) is 30% or more, the initial discharging capacity can be prevented from decreasing due to substitution of Li site.

(5) The cathodic active material as set forth in any one of (1) to (4), wherein the particle diameter of primary particles is 5 nm to 100 nm.

The foregoing structure makes it possible to increase the amount of substitution of Li site while suppressing a decrease in the discharging capacity ratio. This makes it possible to further prevent the cathode from expanding or contracting due to charging and discharging, thus making it possible to provide a cathodic active material capable of providing a longer-life battery.

(6) The cathodic active material as set forth in any one of (1) to (5), wherein Fe in general formula (1′) has an average valence of +2.

The foregoing structure makes it possible to better prevent the cathode from expanding or contracting due to charging and discharging, thus making it possible to provide a cathodic active material capable of providing a longer-life battery.

(7) The cathodic active material as set forth in any one of (1) to (6), wherein M in general formula (1′) has a valence of +4.

The cathodic active material as set forth in (7), wherein M in general formula (1′) is Zr or Sn.

The foregoing structure, which is highly effective in suppressing the rate of change in volume, it possible to better prevent the cathode from expanding or contracting due to charging and discharging, thus making it possible to provide a cathodic active material capable of providing a longer-life battery. Further, because Zr and Sn do not change in valence during synthesis of a cathodic active material, the cathodic active material can be synthesized stably.

(9) The cathodic active material as set forth in (7) or (8), wherein M in general formula (1′) is Zr.

(10) The cathodic active material as set forth in any one of (1) to (6), wherein M in general formula (1′) has a valence of +3.

(11) The cathodic active material as set forth in (10), wherein M in general formula (1′) is Y.

The foregoing structure, which is highly effective in suppressing the rate of change in volume, it possible to better prevent the cathode from expanding or contracting due to charging and discharging, thus making it possible to provide a cathodic active material capable of providing a longer-life battery. Further, because Y does not change in valence during synthesis of a cathodic active material, the cathodic active material can be synthesized stably.

(12) A cathode including: such a cathodic active material as set forth in any one of (1) to (11); a conductive body; and a binder.

(13) A nonaqueous secondary battery including: a cathode as set forth in (12); an anode; an electrolyte; and a separator.

The present invention is not limited to the description of the embodiments above, but may be altered by a skilled person within the scope of the claims. An embodiment based on a proper combination of technical means disclosed in different embodiments is encompassed in the technical scope of the present invention.

### EXAMPLES

The present invention is described below in more detail with reference to Examples; however, the present invention is not limited to Examples below. It should be noted that reagents etc. used in Examples are highest quality reagents manufactured by Kishida Chemical Co., Ltd.

[References 1 to 8]

For each of the compounds listed in Table 1, the rate of change in volume of the compound (the rate of change in volume of the volume of a unit lattice in Li₍ₓ₋ₐ₎AₐFe₍₁₋ₓ₎MₓP_{(1-y)}Si_{y}O₄ relative to the volume of a unit lattice in general formula (1)) was calculated according to the VASP, which is a general program for first principle calculation.

Specifically, the volume of a unit lattice having four Li atoms, four Fe atoms, four P atoms, and sixteen O atoms was calculated under the following conditions: ENCUT=400, IBRION=1, ISIF=3, EDIFF=1.0e-05, EDIFFG=−0.02, ISPIN=2. Further, the value U of Fe was 3.71.

The rate of change in volume was calculated according to formula (3):

Rate of change in volume (%)=(V₀−V₁)/V₀×100 (3),

where V₀ is the volume as calculated in the presence of Li and V₁ is the volume as calculated in the absence of Li.

For consideration of the amounts of substitution, calculations were performed on structures twice and four times as large as a unit lattice, with half and a quarter the amount of substitution of each element. Table 1 shows the rates of change in volume thus calculated.

TABLE 1

| | | Values of a | | | | | |
|---|---|---|---|---|---|---|---|
| | | 0.005 | 0.01 | 0.02 | 0.05 | 0.1 | 0.25 |
| Reference 1 | (Li₁₋ₐNaₐ) (Fe_{0.75}Sn_{0.25}) (P_{0.6}Si_{0.5})O₄ | 3.63% | 3.60% | 3.54% | 3.38% | 3.12% | 2.31% |
| Reference 2 | (Li₁₋ₐKₐ) (Fe_{0.75}Sn_{0.25}) (P_{0.6}Si_{0.5})O₄ | 3.62% | 3.59% | 3.54% | 3.37% | 3.08% | 2.23% |
| Reference 3 | (Li₁₋ₐNaₐ) (Fe_{0.75}Y_{0.25}) (P_{0.75}Si_{0.25})O₄ | 2.75% | 2.73% | 2.69% | 2.58% | 2.41% | 1.87% |
| Reference 4 | (Li₁₋ₐKₐ) (Fe_{0.75}Y_{0.25}) (P_{0.75}Si_{0.25})O₄ | 2.75% | 2.73% | 2.69% | 2.59% | 2.42% | 1.89% |
| Reference 5 | (Li₁₋ₐNaₐ) (Fe_{0.75}Al_{0.25}) (P_{0.75}Si_{0.25})O₄ | 4.05% | 4.03% | 3.99% | 3.88% | 3.70% | 3.15% |
| Reference 6 | (Li₁₋ₐKₐ) (Fe_{0.75}Al_{0.25}) (P_{0.75}Si_{0.25})O₄ | 4.01% | 3.96% | 3.85% | 3.54% | 3.02% | 1.45% |
| Reference 7 | (Li₁₋ₐNaₐ) (Fe_{0.75}Zr_{0.25}) (P_{0.5}Si_{0.5})O₄ | 1.05% | 1.05% | 1.06% | 1.08% | 1.11% | 1.19% |
| Reference 8 | (Li₁₋ₐKₐ) (Fe_{0.75}Zr_{0.25}) (P_{0.5}Si_{0.5})O₄ | 1.05% | 1.06% | 1.07% | 1.11% | 1.18% | 1.38% |

As shown in Table 1, each of the compounds of References 1 to 8 exhibited a low rate of change in volume. This means that each of the compounds of References 1 to 8 has a low rate of change in volume during charging and discharging therefore is a cathodic active material capable of providing a long-life battery.

It should be noted that among values that are calculated according to first principle calculation, such a rate of change in volume is calculated with high reproducibility because the lattice constant is a value that contains few errors in calculation. In fact, as will be described in Reference 10 below, these calculation results coincided highly accurately with values obtained by actually preparing cathodic active materials and measuring their rates of change in volume.

[Reference 9]

Relationships between the amount of substitution of Li site in a cathodic active material according to the present invention and the discharging capacity ratio at different particles diameters were examined.

In Reference 9, assuming that in the cathodic active material according to the present invention, Li atoms diffuse only along the b axis and atoms having replaced Li site do not diffuse, the discharging capacity ratio (%) was calculated according to formula (4),

Discharging capacity ratio (%)={2b(1−a)/(2na+b)}×100 (4)

where n is the particle diameter (nm), a is the amount of substitution of Li site, and b is the length of the unit lattice along the b axis.

Specifically, formula (4) represents {(number of Li atoms present in one diffusion path)/(number of substituting atoms present in one diffusion path+1)×2}/(number of atoms present in one diffusion path)×100, where:

the number of Li atoms present in one diffusion path is equal to 2n(1−a)/b;

the number of substituting atoms present in one diffusion path is equal to 2na/b; and

the number of atoms present in one diffusion path is equal to 2n/b.

Further, formula (4) is a modification of formula, (2), explained in “(1) Cathodic Active Material” above, according to which the discharging capacity ratio is calculated. Therefore, the “initial discharging capacity of unit lattice in general formula (1)” in formula (2) can be calculated by calculating the “initial discharging capacity of unit lattice in LiFe₁₋ₓMₓP_{1-y}Si_{y}O₄” in formula (2) according to formula (5):

Discharging capacity (mAh/g)=F/3600/Mw×1000×(1−x) (5),

where F is the Faraday constant, Mw is the molecular weight of the compound, x is the amount of substitution M on Fe site synonymously with x in general formula (1), and then multiplying it by formula (4).

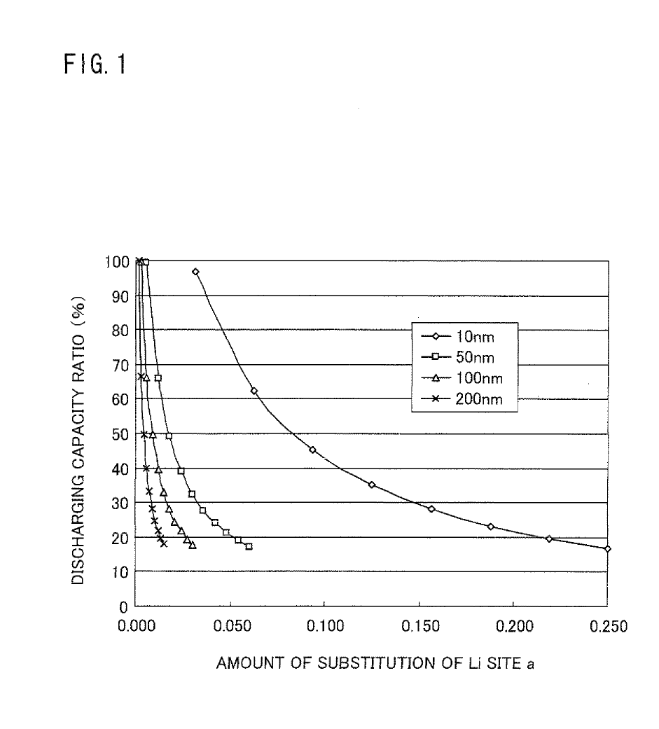

Use of formula (4) makes it possible to calculate what percentage of the theoretical capacity can be obtained according to the size of the crystal and the amount of substitution of Li site, assuming that the component of each cathodic active material has a theoretical capacity of 100%. Further, the discharging capacity ratio calculated according to formula (4) does not depend on the composition of a cathodic active material and therefore applies to the composition of any of the compounds of References 1 to 8. The results are shown in Table 2 and FIG. 1.

TABLE 2

| Particle size (nm) | | | | | | | | | | | |
|---|---|---|---|---|---|---|---|---|---|---|---|
| 10 | Amount of substitution a | 0.031 | 0.063 | 0.094 | 0.125 | 0.156 | 0.188 | 0.219 | 0.250 | 0.281 | 0.313 |
| | Discharging capacity ratio (%) | 96.9% | 62.5% | 45.3% | 35.0% | 28.1% | 23.2% | 19.5% | 16.7% | 14.4% | 12.5% |
| 50 | Amount of substitution a | 0.006 | 0.012 | 0.018 | 0.024 | 0.030 | 0.036 | 0.042 | 0.048 | 0.054 | 0.060 |
| | Discharging capacity ratio (%) | 99.4% | 65.9% | 49.1% | 39.0% | 32.3% | 27.5% | 23.9% | 21.2% | 18.9% | 17.1% |
| 100 | Amount of substitution a | 0.003 | 0.006 | 0.009 | 0.012 | 0.015 | 0.018 | 0.021 | 0.024 | 0.027 | 0.030 |
| | Discharging capacity ratio (%) | 99.7% | 66.3% | 49.5% | 39.5% | 32.8% | 28.1% | 24.5% | 21.7% | 19.5% | 17.6% |
| 200 | Amount of substitution a | 0.002 | 0.003 | 0.005 | 0.006 | 0.008 | 0.009 | 0.011 | 0.012 | 0.014 | 0.015 |
| | Discharging capacity ratio (%) | 99.8% | 66.5% | 49.8% | 39.8% | 33.1% | 28.3% | 24.7% | 22.0% | 19.7% | 17.9% |

FIG. 1 is a graph showing the results shown in Table 2, i.e. a graph showing relationships between the amount of substitution a of Li site in general formula (1) and the discharging capacity ratio for a cathodic active material at different particles diameters of 10 nm, 50 nm, 100 nm, and 200 nm.

As shown in FIG. 1, regardless of the particle size of the cathodic active material, an increase in amount of substitution a of Li site led to a decrease in discharging capacity ratio. This is presumably because the increase in amount of substitution a of Li site causes an increase in Li atoms that do not contribute to insertion or desorption and the increase in Li atoms leads to a decrease in initial discharging capacity of the battery.

Further, as shown in Table 2, it was confirmed that a cathodic active material having a discharging capacity ratio of 30% or more can be provided even if the amount of substitution a of Li site is increased for a decrease in rate of change in volume, so long as the particle size of each of the compounds of References 1 to 8 is 100 nm or smaller. This means that a cathodic active material that can provide a long-life battery while securing a certain level of initial discharging capacity can be provided, so long as the particle size is 100 nm or smaller.

[Reference 10]

The accuracy of the calculation results was confirmed by actually preparing cathodic active materials from LiFePO₄ and FePO₄, respectively, and calculating their rates of change in volume.

### Synthesis of LiFePO₄

A lithium source LiOH, an iron source Fe(CH₃COO)₂, and a phosphate source H₃PO₄ were used as starting materials, and these starting materials were measured out so that the molar ratio was Li:Fe:P1:1:1. Next, the Fe source and the P source were put into a small amount of water, and the Li source was put after the Fe source had been completely dissolved. Into this aqueous solution, sucrose containing 20 percent by mass of LiFePO₄, which would be a final product, was added. This aqueous solution was dried overnight at 60° C. in a drying furnace under a nitrogen flow, and then sintered for twelve hours at 600° C. Thus synthesized was LiFePO₄ single-phase powder, which is an olivine-type cathodic active material.

<Measurement of the Rate of Change in Volume>

The LiFePO₄ cathodic active material thus synthesized was crushed in a mortar into fine powder, and the lattice constant was calculated by X-ray measurement at 10° to 90° at room temperature with use of a Cu tube.

Further, the lattice constant of an active material after desorption of Li was calculated by using, as a cathodic active material after Li desorption, a cathodic active material whose charging capacity had been confirmed and which had the same composition as in a state of Li desorption and performing X-ray measurement on the cathodic active material at room temperature. Specifically, XRD measurement of the cathodic active material after Li desorption was performed after preparing a battery according to the after-mentioned method for preparing a battery, taking out the cathode with the battery fully charged, and then washing the cathode with ethanol.

After calculating the volume of a structure during charging and the volume of the structure during discharging according to the lattice constant of the structure during charging and the lattice constant of the structure during discharging, the rate of change in volume (%) due to charging and discharging was calculated according to formula (6):

Rate of expansion in volume (%)=(1−volume of structure during charging/volume of structure during discharging)×100 (6).

It should be noted here that the structure during charging is a structure during Li desorption and the structure during discharging is an initial structure during synthesis.

<Method for Preparing a Battery>

After the cathodic active material, acetylene black (marketed as “Denka Black”; manufactured by Denki Kagaku Kogyo Kabushiki Kaisha), and PVdF (polyvinylidene fluoride) (marketed as “KF Polymer”; manufactured by Kureha Corporation) were mixed with a mass ratio of 70:30:10, the mixture was mixed with N-methylpyrrolidone (manufactured by Kishida Chemical Co., Ltd.) to form slurry. A cathode was obtained by applying the slurry onto a 20-μm-thick aluminum foil so that the cathode had a thickness of 50 μm to 100 μM. It should be noted that the cathode had an electrode size of 2 cm×2 cm.

After the cathode had been dried, the cathode was used as an electrode and Li metal was used as a counter electrode, with 50 ml of an electrolyte contained in a 100-ml glass container. The electrolyte (manufactured by Kishida Chemical Co., Ltd.) used was obtained by dissolving LiPF₆ in a solvent so that the concentration was 1.4 mol/l, and the solvent used was obtained by mixing ethylene carbonate and diethyl carbonate with a volume ratio of 7:3.

The results are shown in Table 3.

TABLE 3

| | | Experimental | Calculated |
|---|---|---|---|
| Compositions | Items | values | values |
| LiFePO₄ | a axis (Å) | 10.33 | 10.207 |
| | b axis (Å) | 6.01 | 5.978 |
| | c axis (Å) | 4.69 | 4.666 |
| | Volume (Å³) | 291.17 | 284.71 |
| FePO₄ | a axis (Å) | 9.82 | 9.753 |
| | b axis (Å) | 5.79 | 5.73 |
| | c axis (Å) | 4.79 | 4.737 |
| | Volume (Å³) | 272.35 | 264.73 |
| | Rate of change | 6.5 | 7.0 |
| | in volume (%) | | |

As shown in Table 3, each of the actually prepared cathodic active materials exhibited a rate of change in volume of 6.5%, which is almost the same as the calculated value of 7.0%.

[Reference 11]

A lithium source Li(OC₂H₅), a sodium source NaOH, an iron source Fe(CH₃COO)₂, a zirconium source Zr(OC₂H₅)₄, a phosphate source (NH₄)₂HPO₄, and a silicon source Si(OC₂H₅)₄ were used as starting materials, and these starting materials were measured out so that the molar ratio was Li:Na:Fe:Zr:P:Si=0.99:0.01:0.875:0.125:0.75:0.25. Next, the Li source, the Zr source, and the Si source were dissolved in 20 g of butanol. Further, the Na source, the Fe source, and the P source were dissolved in water whose number of moles was four times as large as that total number of moles of metal alcoxide (the Fe source, the Si source, and the Li source). After one hour of stirring of a mixture of the butanol, in which the metal alcoxide had been dissolved, and the water, in which the Fe source and the P source had been dissolved, the resulting mixture was dried at 60° C. in a dryer into a powdery precursor.

The resultant amorphous precursor was sintered for twelve hours at 600° C. in a nitrogen atmosphere. Thus synthesized was Li_{0.99}Na_{0.001}Fe_{0.875}Zr_{0.125}P_{0.75}Si_{0.25}O₄ single-phase powder, which is an olivine-type cathodic active material. The lattice constants of the resultant cathodic active material along the a axis, the b axis, and the c axis were 10.336 Å, 6.025 Å, and 4.728 Å, respectively.

### Example 1

A lithium source LiCH₃COO, an iron source Fe(NO₃)₃.9H₂O, a zirconium source ZrCl₄, a phosphate source H₃PO₄ (85%), and a silicon source Si(OC₂H₅)₄ were used as starting materials. These starting materials were measured out so that the molar ratio is Li:Fe:Zr:P:Si=1:0.875:0.125:0.825:0.25, with the lithium source LiCH₃COO used in an amount of 1.3196 g. These starting materials were dissolved in 30 ml of C₂H₅₀H and stirred by a stirrer for 48 hours at room temperature. After that, the solvent was removed at 40° C. in a constant-temperature bath, with the result that a brownish-red powder was obtained.

After addition of 15 percent by weight of sucrose relative to the resultant powder, they were mixed well in an agate mortar, and the resulting mixture was pressure-molded into pellets. The pellets were sintered for twelve hours at 500° C. in a nitrogen atmosphere. Thus synthesized was Li_{0.99}Fe_{0.01}Fe_{0.865}Zr_{0.125}P_{0.75}Si_{0.25}O₄ single-phase powder. The resultant cathodic active material is referred to as “Al”.

A cathodic electrode was prepared by carrying out the same operation as in Reference 10 on the cathodic active material Al.

### Example 2

A lithium source LiCH₃COO, an iron source Fe(NO₃)₃.9H₂O, a zirconium source ZrCl₄, a phosphate source H₃PO₄ (85%), and a silicon source Si(OC₂H₅)₄ were used as starting materials. These starting materials were measured out so that the molar ratio is Li:Fe:Zr:P:Si=1:0.9:0.1:0.88:0.2, with the lithium source LiCH₃COO used in an amount of 1.3196 g. These starting materials were dissolved in 30 ml of C₂H₅OH and stirred by a stirrer for 48 hours at room temperature. After that, the solvent was removed at 40° C. in a constant-temperature bath, with the result that a brownish-red powder was obtained.

After addition of 15 percent by weight of sucrose relative to the resultant powder, they were mixed well in an agate mortar, and the resulting mixture was pressure-molded into pellets. The pellets were sintered for twelve hours at 500° C. in a nitrogen atmosphere. Thus synthesized was Li_{0.989}Fe_{0.011}Fe_{0.889}Zr_{0.1}P_{0.8}Si_{0.2}O₄ single-phase powder. The resultant cathodic active material is referred to as “A2”.

A cathodic electrode was prepared by carrying out the same operation as in Reference 10 on the cathodic active material A2.

### Example 3

A lithium source LiCH₃COO, an iron source Fe(NO₃)₃.9H₂O, a zirconium source ZrCl₄, a phosphate source H₃PO₄ (85%), and a silicon source Si(OC₂H₅)₄ were used as starting materials. These starting materials were measured out so that the molar ratio is Li:Fe:Zr:P:Si=1:0.95:0.05:0.99:0.1, with the lithium source LiCH₃COO used in an amount of 1.3196 g. These starting materials were dissolved in 30 ml of C₂H₅OH and stirred by a stirrer for 48 hours at room temperature. After that, the solvent was removed at 40° C. in a constant-temperature bath, with the result that a brownish-red powder was obtained.

After addition of 15 percent by weight of sucrose relative to the resultant powder, they were mixed well in an agate mortar, and the resulting mixture was pressure-molded into pellets. The pellets were sintered for twelve hours at 500° C. in a nitrogen atmosphere. Thus synthesized was Li_{0.978}Fe_{0.022}Fe_{0.928}Zr_{0.05}P_{0.9}Si_{0.1}O₄ single-phase powder. The resultant cathodic active material is referred to as “A3”.

A cathodic electrode was prepared by carrying out the same operation as in Reference 10 on the cathodic active material A3.

### Example 4

A lithium source LiCH₃COO, an iron source Fe(NO₃)₃.9H₂O, a zirconium source ZrCl₄, an aluminum source AlCl₃.6H₂O, a phosphate source H₃PO₄ (85%), and a silicon source Si(OC₂H₅)₄ were used as starting materials. These starting materials were measured out so that the molar ratio is Li:Fe:Zr:Al:P:Si=1:0.875:0.0625:0.0625:0.8125:0.1875, with the lithium source LiCH₃COO used in an amount of 1.3196 g. These starting materials were dissolved in 30 ml of C₂H₅OH and stirred by a stirrer for 48 hours at room temperature. After that, the solvent was removed at 40° C. in a constant-temperature bath, with the result that a brownish-red powder was obtained.

After addition of 15 percent by weight of sucrose relative to the resultant powder, they were mixed well in an agate mortar, and the resulting mixture was pressure-molded into pellets. The pellets were sintered for twelve hours at 500° C. in a nitrogen atmosphere. Thus synthesized was Li_{0.99}Fe_{0.01}Fe_{0.865}Zr_{0.0625}Al_{0.0625}P_{0.8125}Si_{0.1875}O₄ single-phase powder. The resultant cathodic active material is referred to as “A4”.

A cathodic electrode was prepared by carrying out the same operation as in Reference 10 on the cathodic active material A4.

### Example 5

A lithium source LiCH₃COO, an iron source Fe(NO₃)₃.9H₂O, a zirconium source ZrCl₄, an aluminum source AlCl₃.6H₂O, a phosphate source H₃PO₄ (85%), and a silicon source Si(OC₂H₅)₄ were used as starting materials. These starting materials were measured out so that the molar ratio is Li:Fe:Zr:Al:P:Si=1:0.875:0.1:0.025:0.8525:0.225, with the lithium source LiCH₃COO used in an amount of 1.3196 g. These starting materials were dissolved in 30 ml of C₂H₅OH and stirred by a stirrer for 48 hours at room temperature. After that, the solvent was removed at 40° C. in a constant-temperature bath, with the result that a brownish-red powder was obtained.

After addition of 15 percent by weight of sucrose relative to the resultant powder, they were mixed well in an agate mortar, and the resulting mixture was pressure-molded into pellets. The pellets were sintered for twelve hours at 500° C. in a nitrogen atmosphere. Thus synthesized was Li_{0.985}Fe_{0.015}Fe_{0.86}Zr_{0.1}Al_{0.025}P_{0.775}Si_{0.225}O₄ single-phase powder. The resultant cathodic active material is referred to as “A5”.

A cathodic electrode was prepared by carrying out the same operation as in Reference 10 on the cathodic active material A5.

### Example 6

A lithium source LiCH₃COO, an iron source Fe(NO₃)₃.9H₂O, a zirconium source ZrCl₄, a phosphate source H₃PO₄ (85%), and a silicon source Si(OC₂H₅)₄ were used as starting materials. These starting materials were measured out so that the molar ratio is Li:Fe:Zr:P:Si=1:0.875:0.125:0.75:0.25, with the lithium source LiCH₃COO used in an amount of 1.3196 g. These starting materials were dissolved in 25 ml of C₂H₅OH and stirred by a stirrer for 48 hours at room temperature. After that, the solvent was removed at 40° C. in a constant-temperature bath, with the result that a brownish-red powder was obtained.

After addition of 15 percent by weight of sucrose relative to the resultant powder, they were mixed well in an agate mortar, and the resulting mixture was pressure-molded into pellets. The pellets were sintered for twelve hours at 500° C. in a nitrogen atmosphere. Thus synthesized was Li_{0.938}Fe_{0.062}Fe_{0.813}Zr_{0.125}P_{0.75}Si_{0.25}O₄ single-phase powder. The resultant cathodic active material is referred to as “A6”.

A cathodic electrode was prepared by carrying out the same operation as in Reference 10 on the cathodic active material A6.

### Example 7

A lithium source LiCH₃COO, an iron source Fe(NO₃)₃.9H₂O, an aluminum source AlCl₃.6H₂O, a phosphate source H₃PO₄ (85%), and a silicon source Si(OC₂H₅)₄ were used as starting materials. These starting materials were measured out so that the molar ratio is Li:Fe:Al:P:Si=1:0.875:0.125:0.75:0.125, with the lithium source LiCH₃COO used in an amount of 1.3196 g. These starting materials were dissolved in 30 ml of C₂H₅OH and stirred by a stirrer for 48 hours at room temperature. After that, the solvent was removed at 40° C. in a constant-temperature bath, with the result that a brownish-red powder was obtained.

After addition of 15 percent by weight of sucrose relative to the resultant powder, they were mixed well in an agate mortar, and the resulting mixture was pressure-molded into pellets. The pellets were sintered for twelve hours at 500° C. in a nitrogen atmosphere. Thus synthesized was Li_{0.995}Fe_{0.005}Fe_{0.87}Al_{0.125}P_{0.875}Si_{0.125}O₄ single-phase powder. The resultant cathodic active material is referred to as “A7”.

A cathodic electrode was prepared by carrying out the same operation as in Reference 10 on the cathodic active material A7.

<Structural Analysis>

The cathodic active materials A1 to A7 thus obtained were each crushed in an agate mortar and subjected to a X-ray analysis apparatus (marketed as MiniFlexII; manufactured by Rigaku Co., Ltd.) to give a powder X-ray diffraction pattern. Next, with reference to “RIETAN-2000” (F. Izumi & T. Ikeda, Mater. Sci. Forum, 321-324 (2000) 198-203), a structural analysis of the resultant powder X-ray diffraction pattern was carried out according to Rietveld analysis whereby in Example 1 the parameters shown in Table 4 were used as default values. It should be noted that the structure was sophisticated under such conditions that the rates of occupation of 4a site by iron and Li satisfied the following formula:

Rate of occupation of 4a site by iron+rate of occupation of 4a site by lithium=1.

In the other examples, structural analyses were carried out with varying types and amounts of substituting element.

The structure was sophisticated by fixing the other rates of occupation at the default values shown in Table 4.

TABLE 4
Space group Pnma
Lattice constants

| a | b | c |
|---|---|---|
| 10.36 | 6.01 | 4.7 |

| | Elements | | | | |
|---|---|---|---|---|---|
| | | Rates of | | | |
| | Sites | occupation | x | y | z |
| Li | 4a | 1.000 | 0.000 | 0.000 | 0.000 |
| Fe | 4a | 0.000 | 0.000 | 0.000 | 0.000 |
| Fe | 4c | 0.875 | 0.278 | 0.250 | 0.970 |
| Zr | 4c | 0.125 | 0.278 | 0.250 | 0.970 |
| P | 4c | 0.750 | 0.101 | 0.250 | 0.423 |
| Si | 4c | 0.250 | 0.101 | 0.250 | 0.423 |
| 0 | 4c | 1.000 | 0.100 | 0.250 | 0.729 |
| 0 | 4c | 1.000 | 0.456 | 0.250 | 1.970 |
| 0 | 8d | 1.000 | 0.163 | 0.059 | 0.290 |

<Measurement of the Initial Discharging Capacity and the Rate of Change in Volume>

Batteries were prepared from A1 to A7, respectively, in the same manner as in Reference 10.

Each of the batteries thus prepared was first charged in an environment of 25° C. The charging current was 0.1 mA, and the charging was finished at a point in time where the battery reached a potential of 4V. After the charging was finished, the battery was discharged at 0.1 mA, and the discharging was finished at a point in time where the battery reached a potential of 2.0 V, with the result that the actually measured capacity of the battery was obtained. These results are shown in Table 5.

Furthermore, the battery was charged at a constant current of 0.1 mA until 4 V so that lithium was desorbed. After that, the lattice constant after lithium desorption was calculated by taking out the electrode and performing powder X-ray diffractometry on the electrode. Table 5 shows the rates of change in volume as calculated according to general formula (6).

TABLE 5

| | | | Discharging | Rate of change | Amount of substitution | Amount of substitution | Amount of substitution |
|---|---|---|---|---|---|---|---|
| | | Samples | capacity | in volume | of Li site | of Fe site | of P site |
| Example 1 | (LiFe)(FeZr)(PSi)0₄ | A1 | 80.7 mAh/g | 3.5% | 0.010 | 0.125 | 0.25 |
| Example 2 | (LiFe)(FeZr)(PSi)0₄ | A2 | 113.1 mAh/g | 4.1% | 0.011 | 0.1 | 0.2 |
| Example 3 | (LiFe)(FeZr)(PSi)0₄ | A3 | 142.1 mAh/g | 4.8% | 0.022 | 0.05 | 0.1 |
| Example 4 | (LiFe)(FeZrAl)(PSi)0₄ | A4 | 103.8 mAh/g | 4.7% | 0.010 | 0.125 | 0.1875 |
| Example 5 | (LiFe)(FeZrAl)(PSi)0₄ | A5 | 92.0 mAh/g | 4.3% | 0.015 | 0.125 | 0.225 |
| Example 6 | (LiFe)(FeZr)(PSi)0₄ | A6 | 58.0 mAh/g | 4.2% | 0.062 | 0.125 | 0.25 |
| Example 7 | (LiFe)(FeAl)(PSi)0₄ | A7 | 101.1 mAh/g | 5.8% | 0.005 | 0.125 | 0.125 |

### Evaluation of Changes in Thickness During Charging and Discharging

### Example 8

Ten grams of the cathodic active material A2 obtained in Example 2 were weighed out, crushed in an agate mortar, and then mixed with approximately 10 percent by weight of a conductive agent, acetylene black (marketed as “Denka Black”; manufactured by Denki Kagaku Kogyo Kabushiki Kaisha), relative of the cathodic active material and approximately 10 percent by weight of a binding agent, polyvinylidene fluoride resin powder, relative to the cathodic active material.

This mixture was dissolved in a solvent such as N-methyl-2-pyrrolidone to form slurry, and the slurry was applied onto both surfaces of a 20-μm-thick aluminum foil by a doctor blade method so that the amount of application was approximately 20 mg/cm². This electrode was dried, and then oil-pressed so that its thickness was approximately 100 μm, including the thickness of the aluminum foil. Thus prepared was an electrode having an electrode size of 2 cm×2 cm.

After the electrode had been dried, a battery was prepared by using the electrode as a cathode, using Li metal as a counter electrode, and pouring 50 ml of an electrolyte into a 100-ml glass container. The electrolyte (manufactured by Kishida Chemical Co., Ltd.) used was obtained by dissolving LiPF₆ in a solvent so that the concentration was 1.4 mol/l, and the solvent used was obtained by mixing ethylene carbonate and diethyl carbonate with a volume ratio of 7:3.

As a result of charging of the resultant battery at 0.1 mA, a charging capacity of 110 mAh/g was obtained. As a result of measurement of the thickness of the cathode taken out after completion of charging, the cathode had a thickness of 98 μm, while it had had a thickness of 102 μm before the charging.

### Example 9

An electrode was prepared through the same procedure as in Example 8 except that the cathodic active material A7 prepared in Example 7 was used instead of the cathodic active material A2. A battery prepared by using the electrode as cathode was charged and discharged, and the thickness of the cathode was measured. As a result, the cathode had a thickness of 94 μm, while it had had a thickness of 100 μm before the charging.

The results of Examples 8 and 9 show that a cathode according to the present invention has a smaller amount of change in thickness during charging and discharging than a conventional cathode.

### Example 10

### Flat-Plate Laminate Battery

A lithium source LiCH₃COO, an iron source Fe(NO₃)₃.9H₂O, a zirconium source ZrCl₄, a phosphate source H₃PO₄ (85%), and a silicon source Si(OC₂H₅)₄ were used as starting materials. These starting materials were measured out so that the molar ratio is Li:Fe:Zr:P:Si=1:0.875:0.125:0.825:0.25, with the lithium source LiCH₃COO used in an amount of 131.96 g. These starting materials were dissolved in 3000 ml of C₂H₅OH and stirred by a stirring motor for 48 hours at room temperature. After that, the solvent was removed at 40° C. in a constant-temperature bath, with the result that a brownish-red powder was obtained.

Two hundred grams of the resultant brownish-red powder were weighed out, crushed in steps of 10g in an automatic mortar, and then mixed with approximately 10 percent by weight of a conductive agent, acetylene black (marketed as “Denka Black”; manufactured by Denki Kagaku Kogyo Kabushiki Kaisha), relative of the cathodic active material and approximately 10 percent by weight of a binding agent, polyvinylidene fluoride resin powder, relative to the cathodic active material.

This mixture was dissolved in a solvent such as N-methyl-2-pyrrolidone to form slurry, and the slurry was applied onto both surfaces of a 20-μm-thick aluminum foil by a doctor blade method. After the slurry had been applied onto one surface, the same slurry was applied onto the other surface, whereby an electrode as formed on both surfaces of the metal foil. It should be noted that the slurry was applied so that the amount of application per surface was approximately 15 mg/cm².

After the electrode had been dried, a cathodic electrode was prepared by pressing the electrode by passing it through a space between two metal rollers placed at a distance of approximately 130 μm, in order that its thickness was approximately 150 μm, including the thickness of the aluminum foil.

It should be noted that the resulting cathodic electrode contains a cathodic active material having a composition represented by Li_{0.99}Fe_{0.01}Fe_{0.865}Zr_{0.125}P_{0.75}Si_{0.25}O₄, a conductive body, and a binder.

Next, approximately 500 g of natural graphite powder having an average particle diameter of approximately 5 μm were weight out as an anodic active material, and this anodic active material was mixed with approximately 10 percent by weight of a binding agent, polyvinylidene fluoride resin powder, relative to the anodic active material.

This mixture was dissolved in a solvent such as N-methyl-2-pyrrolidone to form slurry, and the slurry was applied onto both surfaces of a 12-μm-thick copper foil by a doctor blade method. After the slurry had been applied onto one surface, the same slurry was applied onto the other surface, whereby an electrode as formed on both surfaces of the metal foil. It should be noted that the amount of application per surface was approximately 7 mg/cm².

After the electrode had been dried, an anodic electrode was prepared by pressing the electrode by passing it through a space between two metal rollers placed at a distance of approximately 120 μm, in order that its thickness was approximately 140 μm, including the thickness of the copper foil.

The cathodic electrode thus obtained was cut into ten cathodic electrodes each having a width of 10 cm and a height of 15 cm. Similarly, the anodic electrode was cut into eleven anodic electrodes each having a width of 10.6 cm and a height of 15.6 cm. It should be noted that the cathodes and the anodes had their shorter sides provided with unpainted parts each having a width of 10 mm and a length of 25 mm, and these unpainted parts served as collector tabs.

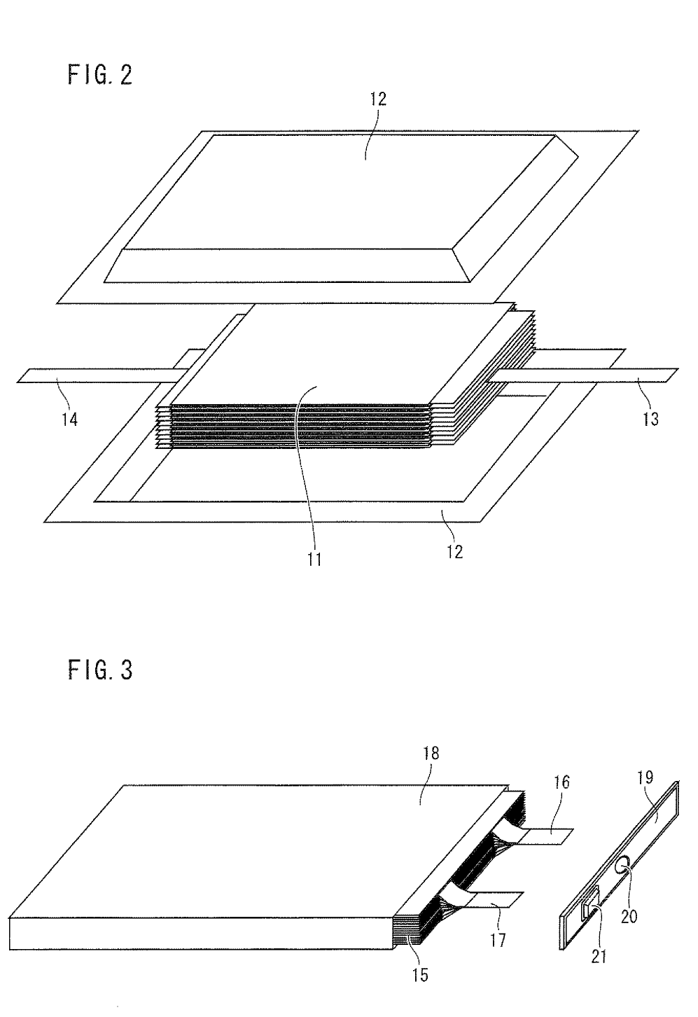

As separators, twenty polypropylene porous films each having a thickness of 25 μm, a width of 11 cm, and a height of 16 cm were used. Such a layered product 11 as shown in FIG. 2 was obtained by: layering the cathodes, the anodes, and the separators in such a way that the separators are disposed on both surfaces of the cathodes so that the anodes and the cathodes do not have direct contact with each other; and fixing them with an adhesive tape made of Kapton resin. Welded ultrasonically to each of the cathode tabs of the layered product 11 was a cathode collector lead 13, made of aluminum, which had a width of 10 mm, a length of 30 mm, and a thickness of 100 μm. Similarly welded ultrasonically to each of the anode tabs was an anode collector lead 14, made of nickel, which had a width of 10 mm, a length of 30 mm, and a thickness of 100 μm.

The layered product 11 thus prepared was placed between two aluminum laminates 12, three of whose sides were heat-sealed. In this state, the layered product 11 was dehydrated by heating it for twelve hours at a temperature of approximately 80° C. in a chamber decompressed by a rotary pump.

The layered product 11 thus dried was placed in a dry box in an Ar atmosphere, and a flat-plate laminate battery was prepared by injecting approximately 50 cc of an electrolyte (manufactured by Kishida Chemical Co., Ltd.) and sealing the opening under reduced pressure. The electrolyte used was obtained by dissolving LiPF₆ in a solvent so that the concentration was 1.4 mol/l, and the solvent used was obtained by mixing ethylene carbonate and diethyl carbonate with a volume ratio of 7:3.

The prepared battery had a thickness of 4.0 mm. A current of 100 mA was applied to this battery, and the charging was finished at a point in time where the battery reached a voltage of 3.9 V. After the charging, the battery had a measured thickness of 4.1 mm. This shows that there was almost no change in thickness during the charging.

### Comparative Example 1

A flat-plate laminate battery was prepared through exactly the same procedure as in Example 7 except that a lithium source LiCH₃COO, an iron source Fe(NO₃)₃.9H₂O, and a phosphate source H₃PO₄ (85%) were used as starting materials and that these starting materials were measured out so that the molar ratio is Li:Fe:P=1:1:1, with the lithium source LiCH₃COO used in an amount of 131.96 g.

The prepared battery had a thickness of 4.0 mm. A current of 100 mA was applied to this battery, and the charging was finished at a point in time where the battery reached a voltage of 3.9 V. After the charging, the battery had a measured thickness of 4.6 mm.

The results of Example 10 and Comparative Example 1 show that a battery in which a cathode according to the present invention is used changes less in thickness than a battery in which a conventional cathode is used.

### Example 11

### Layered Cuboidal Battery

A lithium source LiCH₃COO, an iron source Fe(NO₃)₃.9H₂O, a zirconium source ZrCl₄, a phosphate source H₃PO₄ (85%), and a silicon source Si(OC₂H₅)₄ were used as starting materials. These starting materials were measured out so that the molar ratio is Li:Fe:Zr:P:Si=1:0.875:0.125:0.825:0.25, with the lithium source LiCH₃COO used in an amount of 1319.6 g. These starting materials were dissolved in 30 L of C₂H₅OH and stirred by a stirring motor for 48 hours at room temperature. After that, the solvent was removed at 40° C. in a constant-temperature bath, with the result that a brownish-red powder was obtained.

One thousand grams of the resultant brownish-red powder were weighed out, crushed in steps of 10 g in an automatic mortar, and then mixed with approximately 10 percent by weight of a conductive agent, acetylene black (marketed as “Denka Black”; manufactured by Denki Kagaku Kogyo Kabushiki Kaisha), relative of the cathodic active material and approximately 10 percent by weight of a binding agent, polyvinylidene fluoride resin powder, relative to the cathodic active material.

This mixture was dissolved in a solvent such as N-methyl-2-pyrrolidone to form slurry, and the slurry was applied onto both surfaces of a 20-μm-thick aluminum foil by a doctor blade method. After the slurry had been applied onto one surface, the same slurry was applied onto the other surface, whereby an electrode as formed on both surfaces of the metal foil. It should be noted that that the amount of application per surface was approximately 15 mg/cm².

After the electrode had been dried, a cathodic electrode was prepared by pressing the electrode by passing it through a space between two metal rollers placed at a distance of approximately 130 μm, in order that its thickness was approximately 150 μm, including the thickness of the aluminum foil.

It should be noted that the resulting cathodic electrode contains a cathodic active material having a composition represented by Li_{0.99}Fe_{0.01}Fe_{0.865}Zr_{0.125}P_{0.75}Si_{0.25}O₄, a conductive body, and a binder.

Next, approximately 500 g of natural graphite powder having an average particle diameter of approximately 5 μm were weight out as an anodic active material, and this anodic active material was mixed with approximately 10 percent by weight of a binding agent, polyvinylidene fluoride resin powder, relative to the anodic active material.

This mixture was dissolved in a solvent such as N-methyl-2-pyrrolidone to form slurry, and the slurry was applied onto both surfaces of a 12-μm-thick copper foil by a doctor blade method. After the slurry had been applied onto one surface, the same slurry was applied onto the other surface, whereby an electrode as formed on both surfaces of the metal foil. It should be noted that the amount of application per surface was approximately 7 mg/cm².

After the electrode had been dried, an anodic electrode was prepared by pressing the electrode by passing it through a space between two metal rollers placed at a distance of approximately 120 μm, in order that its thickness was approximately 140 μm, including the thickness of the copper foil.

The cathodic electrode thus obtained was cut into ten cathodic electrodes each having a width of 10 cm and a height of 15 cm. Similarly, the anodic electrode was cut into eleven anodic electrodes each having a width of 10.6 cm and a height of 15.6 cm. It should be noted that the cathodes and the anodes had their shorter sides provided with unpainted parts each having a width of 10 mm and a length of 25 mm, and these unpainted parts served as collector tabs.

As separators, twenty polypropylene porous films each processed to have a thickness of 25, a width of 11 cm, and a height of 16 cm were used.

Such a layered product 15 as shown in FIG. 3 was obtained by: layering the cathodes, the anodes, and the separators in such a way that the separators are disposed on both surfaces of the cathodes so that the anodes and the cathodes do not have direct contact with each other; and fixing them with an adhesive tape made of Kapton resin.

Welded ultrasonically to each of the cathode tabs of the layered product 15 was a cathode collector lead 16, made of aluminum, which had a width of 10 mm, a length of 30 mm, and a thickness of 100 μm. Similarly welded ultrasonically to each of the anode tabs was an anode collector lead 17, made of nickel, which had a width of 10 mm, a length of 30 mm, and a thickness of 100 μm.

The layered product 15 was dehydrated by heating it for twelve hours at a temperature of approximately 80° C. in a chamber decompressed by a rotary pump.

The layered product 15 thus dried was inserted into a battery can 18 in a dry box in an Ar atmosphere, and the collector leads 16 and 17 of the layered product 15 were welded ultrasonically to the ends of collector terminals (cathode terminals, anode terminals 21) of a battery lid 19 provided with two piercing terminals and made of an aluminum metal plate. It should be noted that the battery can 18 used was a 1-mm-thick aluminum can shaped into cuboid with the dimensions 12 cm×18 cm×2 cm and provided with a safety valve 20.

Then, the battery lid 19 was fitted in the opening of the battery can 18, and the battery was sealed by laser-welding the joint.

A cuboidal battery was prepared by injecting approximately 300 cc of an electrolyte (manufactured by Kishida Chemical Co., Ltd.) through a hole of 1 mm diameter made in the battery lid 19 and then sealing the injection hole by laser welding. The electrolyte used was obtained by dissolving LiPF₆ in a solvent so that the concentration was 1.4 mol/l, and the solvent used was obtained by mixing ethylene carbonate and diethyl carbonate with a volume ratio of 7:3.

The prepared battery had a thickness of 20.1 mm in its central part. A current of 100 mA was applied to this battery, and the charging was finished at a point in time where the battery reached a voltage of 3.9 V. After the charging, the battery had a measured thickness of 20.0 mm in its central part. This shows that there was almost no change in thickness during the charging.

### Comparative Example 2

A lithium source LiCH₃COO, an iron source Fe(NO₃)₃.9H₂O, and a phosphate source H₃PO₄ (85%) were used as starting materials. A layered cuboidal battery was prepared through exactly the same procedure as in Example 11 except that these starting materials were measured out so that the molar ratio is Li:Fe:P=1:1:1, with the lithium source LiCH₃COO used in an amount of 131.96 g.

The prepared battery had a thickness of 20.1 mm in its central part. A current of 100 mA was applied to this battery, and the charging was finished at a point in time where the battery reached a voltage of 3.9 V. After the charging, the battery had a measured thickness of 20.8 mm in its central part.

The results of Example 11 and Comparative Example 2 show that a battery in which a cathode according to the present invention is used changes less in thickness than a battery in which a conventional cathode is used.

### Evaluation of the Capacity Retention Rate of a Wound Cylindrical Battery

### Example 12

### Wound Cylindrical Battery

A lithium source LiCH₃COO, an iron source Fe(NO₃)₃.9H₂O, a zirconium source ZrCl₄, a phosphate source H₃PO₄ (85%), and a silicon source Si(OC₂H₅)₄ were used as starting materials. These starting materials were measured out so that the molar ratio is Li:Fe:Zr:P:Si 1:0.875:0.125:0.825:0.25, with the lithium source LiCH₃COO used in an amount of 1319.6 g. These starting materials were dissolved in 30 L of C₂H₅OH and stirred by a stirring motor for 48 hours at room temperature. After that, the solvent was removed at 40° C. in a constant-temperature bath, with the result that a brownish-red powder was obtained.

One thousand grams of the resultant brownish-red powder were weighed out, crushed in steps of 10 g in an automatic mortar, and then mixed with approximately 10 percent by weight of a conductive agent, acetylene black (marketed as “Denka Black”; manufactured by Denki Kagaku Kogyo Kabushiki Kaisha), relative of the cathodic active material and approximately 10 percent by weight of a binding agent, polyvinylidene fluoride resin powder, relative to the cathodic active material.

This mixture was dissolved in a solvent such as N-methyl-2-pyrrolidone to form slurry, and the slurry was applied onto both surfaces of a 20-μm-thick aluminum foil by a doctor blade method. After the slurry had been applied onto one surface, the same slurry was applied onto the other surface, whereby an electrode as formed on both surfaces of the metal foil. It should be noted that that the amount of application per surface was approximately 15 mg/cm².

After the electrode had been dried, a cathodic electrode was prepared by pressing the electrode by passing it through a space between two metal rollers placed at a distance of approximately 130 μm, in order that its thickness was approximately 150 μm, including the thickness of the aluminum foil.

It should be noted that the resulting cathodic electrode contains a cathodic active material having a composition represented by Li_{0.99}Fe_{0.01}Fe_{0.865}Zr_{0.125}P_{0.75}Si_{0.25}O₄, a conductive body, and a binder.

Next, approximately 500 g of natural graphite powder having an average particle diameter of approximately 5 μm were weight out as an anodic active material, and this anodic active material was mixed with approximately 10 percent by weight of a binding agent, polyvinylidene fluoride resin powder, relative to the anodic active material.

This mixture was dissolved in a solvent such as N-methyl-2-pyrrolidone to form slurry, and the slurry was applied onto both surfaces of a 12-μm-thick copper foil by a doctor blade method. After the slurry had been applied onto one surface, the same slurry was applied onto the other surface, whereby an electrode as formed on both surfaces of the metal foil. It should be noted that the amount of application per surface was approximately 7 mg/cm².

After the electrode had been dried, an anodic electrode was prepared by pressing the electrode by passing it through a space between two metal rollers placed at a distance of approximately 120 μm, in order that its thickness was approximately 140 μm, including the thickness of the copper foil.

The cathodic electrode thus obtained was cut so as to have a width of 5 cm and a length of 150 cm. Similarly, the anodic electrode was cut so as to have a width of 5.2 cm and a height of 160 cm.

The cathodes and the anodes had their shorter sides provided with unpainted parts to which collector tabs were welded. Welded ultrasonically to each of the unpainted parts was a metal lead having a width of 4 mm, a thickness of 100 μm, and a length of 10 cm. Further, as those metal leads for the cathodes were made of aluminum, and those for the anodes were made of nickel.

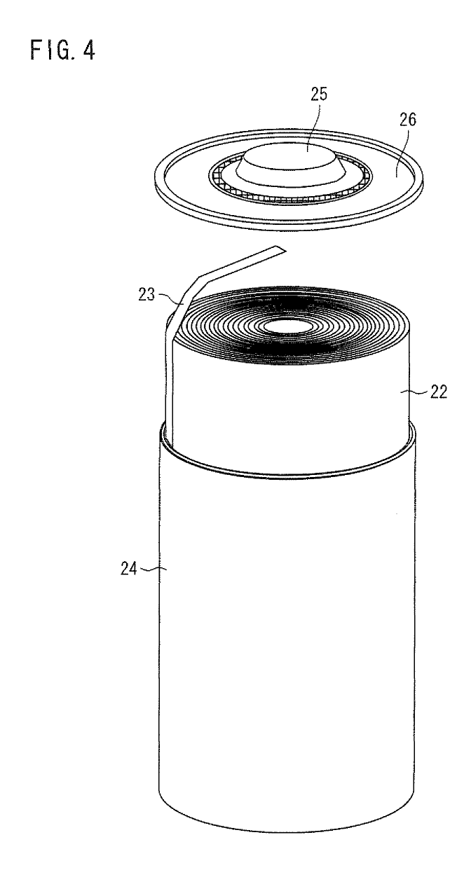

As a separator, a polypropylene porous film processed to have a width of 6 cm and a length of 350 cm was used. The separator was folded in half so as to have a width of 6 cm and a length of 175 cm, and the cathode was sandwiched between the halves. Such a cylindrical wound product 22 as shown in FIG. 4 was obtained by putting the anode on top of the intermediate product and winding it around a polyethylene spindle having a diameter of 5 mm and a length of 6.5 cm. The final wound product 22 was bound tightly with a Kapton tape so as not to be unwound.

The wound product 22 thus prepared was dehydrated by heating it for twelve hours at a temperature of approximately 80° C. in a chamber decompressed by a rotary pump. It should be noted that this operation was carried out in an argon dry box at a dew point of −40° C. or lower.

An aluminum pipe, having a diameter of 30 mm and a length of 70 mm, one end of which had been closed by welding an aluminum disc having a diameter of 30 cm was used as a battery can 24. It should be noted that a bottom lid was joined by laser welding.

The wound product 22 was inserted into the battery can 24 and, as shown in FIG. 4, a cathode collector lead 23 was spot-welded to a cathode terminal 25 of a battery lid 26, and an anode lead (not shown) was spot-welded to the bottom surface of the battery can 24. Then, the battery was sealed by laser-welding the battery lid 26 to the opening of the cylinder.

Then, a cylindrical battery was prepared by injecting approximately 5 cc of an electrolyte (manufactured by Kishida Chemical Co., Ltd.) through a hole of 1 mm diameter made in the battery lid 26 and then sealing the injection hole by laser welding. The electrolyte used was obtained by dissolving LiPF₆ in a solvent so that the concentration was 1.4 mol/l, and the solvent used was obtained by mixing ethylene carbonate and diethyl carbonate with a volume ratio of 7:3.

Five such batteries were prepared. A current of 100 mA was applied to each of the batteries, and the charging was finished at a point in time where the battery reached a voltage of 3.9V and, furthermore, the battery was discharged until 2.2V. This cycle was repeated a hundred times. Table 6 shows the result of an evaluation.

### Comparative Example 30

A lithium source LiCH₃COO, an iron source Fe(NO₃)₃.9H₂O, and a phosphate source H₃PO₄ (85%) were used as starting materials. A cylindrical battery was prepared through exactly the same procedure as in Example 12 except that these starting materials were measured out so that the molar ratio is Li:Fe:P=1:1:1, with the lithium source LiCH₃COO used in an amount of 131.96 g.

Table 6 shows the result of a charge-discharge evaluation carried out through exactly the same procedure as in Example 12. As shown in Table 6, it was confirmed that the battery of the present invention has a higher capacity retention ratio and a longer life than the comparative example.

TABLE 6

| | Initial discharging | Capacity |
|---|---|---|
| | capacity (Ah) | retention ratio (%) |
| Example 12 | 2.58 | 97.2 |
| Comp. Ex. 3 | 2.88 | 93.8 |

### INDUSTRIAL APPLICABILITY

A cathodic active material of the present invention not only excels in terms of safety and cost but also can provide a long-life battery, and as such, can be suitably used as a cathodic active material in a nonaqueous secondary battery such as a lithium ion battery.

### REFERENCE SIGNS LIST

11, 15 Layered product
12 Aluminum laminate
13, 16, 23 Cathode collector lead
14, 17 Anode collector lead
18, 24 Battery can
19, 26 Battery lid
20 Safety valve
21 Anode terminal
22 Wound product
25 Cathode terminal

1. A cathodic active material comprising a composition represented by general formula (1):
Li₍₁₋ₐ₎AₐFe_{(1-x-b)}M_{(x-c)}P_{(1-y)}Si_{y}O₄ (1),
where A is at least one type of element selected from the group consisting of Na, K, Fe, and M; Fe has an average valence of +2 or more; M is an element having a valence of +2 or more and at least one type of element selected from the group consisting of Zr, Sn, Y, and Al, the average valence of M being different from the average valence of Fe; 0<a≦0.125; a=b+c+d, where b is the number of moles of Fe in A, c is the number of moles of M in A, and d is the total number of moles of Na and K in A; 0<x≦0.5; and 0<y≦0.5.

2. The cathodic active material as set forth in claim 1, wherein assuming that k is the content of Li in general formula (1), the rate of change in volume of the volume of a unit lattice in a case where k is (x+b−a) (where k is 0 when x+b−a<0) relative to the volume of a unit lattice in a case where k is (1−a) is 5% or less.

3. The cathodic active material as set forth in claim 1, wherein A in general formula (1) is Fe or M.

4. The cathodic active material as set forth in claim 1, wherein M in general formula (1) has a valence of +4.

5. The cathodic active material as set forth in claim 4, wherein M in general formula (1) is Zr.

6. The cathodic active material as set forth in claim 1, wherein M in general formula (1) includes at least Zr and Al.

7. A cathode comprising:
a cathodic active material as set forth in claim 1;
a conductive body; and
a binder.

8. A nonaqueous secondary battery comprising:
a cathode as set forth in claim 7;
an anode;
an electrolyte; and
a separator.

9. The nonaqueous secondary battery as set forth in claim 8, said nonaqueous secondary battery being a laminate battery, a layered cuboidal battery, a wound cuboidal battery, or a wound cylindrical battery.

10. A module comprising a combination of nonaqueous secondary batteries as set forth in claim 8.

11. A power storage system comprising a nonaqueous secondary battery as set forth in claim 8.

12. The power storage system as set forth in claim 11, said power storage system being a solar power storage system, a midnight power storage system, a wind power storage system, a geothermal power storage system, or a wave power storage system.
